(19) United States
(12) Patent Application Publication
(10) Pub. No.: US 2008/0027264 A1
(43) Pub. Date: Jan. 31, 2008

(54) Methods for degrading phenolic biocides present in fluid compositions

(76) Inventor: Peter Hug, Toledo, OH (US)

Correspondence Address: DUNLAP CODDING & ROGERS, P.C., PO BOX 16370, OKLAHOMA CITY, OK, 73113, US

(21) Appl. No.: 11/805,639

(22) Filed: May 24, 2007

Related U.S. Application Data
(60) Provisional application No. 60/803,079, filed on May 24, 2006.

(51) Int. Cl. A62D 3/38

(52) U.S. Cl. 588/320

(57) ABSTRACT

Methods and systems for degrading phenolic biocides in fluid compositions, such as metalworking fluids, prior to waste treatment of such fluid compositions are provided. The methods include adding an effective amount of a peroxy compound that generates peroxide in aqueous or non-polar solution, and adding an effective amount of an oxidative catalyst. The oxidative catalyst is activated by peroxide and degrades the phenolic biocide present in the fluid composition.

### CROSS REFERENCE TO RELATED APPLICATIONS

This application claims benefit under 35 U.S.C. 119(e) of U.S. Ser. No. 60/803,079, filed May 24, 2006; the entire contents of which are hereby expressly incorporated herein by reference in their entirety.

### STATEMENT REGARDING FEDERALLY SPONSORED RESEARCH OR DEVELOPMENT

Not Applicable.

### FIELD OF THE INVENTION

The invention relates to methods and systems for degrading phenolic biocides in fluid compositions, such as metalworking fluid compositions.

### BACKGROUND OF THE INVENTION

Fluid compositions are employed in a variety of tasks and environments wherein knowledge of contaminants present in the fluid composition is important to insuring the proper and effective functioning and utilization of the fluid composition. Such fluid compositions are employed in for example but not by way of limitation, cooling water tower systems, washing operations, machining processes, swimming pools, hydraulic fluids, plating operations, leather treatment fluids, agricultural processing fluids, and the like. Thus, methods and devices for the simple direct determination of the presence of one or more contaminants in a fluid composition, as well as methods of removal of such contaminants therefrom, are important in the industrial arts.

In the shaping of a solid workpiece, such as for example a piece of metal, into a useful article, it is known to apply a cutting or non-cutting tool against the workpiece. This tool and/or the workpiece may be rotated with respect to each other, often at high speeds. Such high speeds are typically found in turning and grinding operations for shaping metals and other solid materials. In other cases, the tool and workpiece are caused to have sliding contact with each other, such as in a punching operation. Still other shaping operations cause a tool to be applied against the workpiece with great force without cutting the workpiece, such as in metal rolling, drawing and ironing processes. High heat and friction are generated during these and other shaping methods, thus causing such problems as tool wear, distortion of the finished article, poor surface finish and out of tolerance dimensions for the article. High scrap rates, tool wear and increased costs result from these problems. To overcome these and other problems, it is known in the art to apply a metalworking fluid to the interface between the tool and the workpiece. The term “metalworking fluid” refers to a complex fluid composition applied to the interface between a tool and a metallic workpiece during the shaping of the workpiece by physical means. Such physical means are principally mechanical means exemplified by grinding, machining, turning, rolling, punching, extruding, spinning, drawing and ironing, stamping and forming, pressing and drilling operations, and the like.

Metalworking fluids (MWFs) are used throughout the manufacturing industry to provide a more efficient material removal or forming operation, and specifically, to lubricate, cool and prevent corrosion of the metal surfaces. Such fluids are selected generally for the purpose of cooling the workpiece and the tool during cutting operations, and to facilitate removal of chips during turning, grinding, and similar operations. MWFs are an important facet of many manufacturing operations in that they provide the required chip and heat removal properties necessary to achieve higher production outputs, increased tool life, and enhanced machined-surface finish and part quality.

The metalworking fluids applied to the interface between the tool and the workpiece in the metalworking art can be broadly classified into two categories. These categories are oils and aqueous based liquids or fluids. The oils are non-aqueous liquids comprising an oil or mixture of oils and one or more additives, such as for example, surfactants, extreme pressure agents, corrosion inhibitors, bactericides, fungicides and odor control agents. Aqueous based metalworking fluids are complex combinations of water, lubricant and additives. Many different lubricants are used in aqueous based metalworking fluids, and aqueous based metalworking fluids can be classified as soluble oils, synthetic fluids and semi synthetic fluids. The lubricants and many other components of aqueous based metalworking fluids are synthetic or naturally occurring organic compounds or mixtures of compounds. Lubricants used in the aqueous based metalworking fluids may include for example esters, amides, polyethers, amines and sulfonated or chlorinated oils. The lubricant component reduces friction between the tool and workpiece while the water helps dissipate the heat generated in the metalworking operation. Corrosion inhibitors are employed to reduce or prevent corrosion of the workpiece and the finished article as well as to reduce or prevent chemical attack on the tool. Bactericides and fungicides are used to reduce or prevent microbial or fungal attack on the constituents of the fluid, while the surfactant may be employed to form a stable suspension of water insoluble components in the water phase of the fluid. Thus, each component of the metalworking fluid has a function contributing to the overall utility and effectiveness of the metalworking fluid.

Many of the molecules used in industrial fluid compositions also serve as nutrient sources for a wide variety of microbes, including but not limited to, bacteria, fungi, yeasts and protists. For example, during its use, a metalworking fluid may undergo increased microbial growth, which results in microbial attack upon the lubricant and/or other components of the MWF composition. Microbial contamination of MWF's can cause one or more consequences such as but not limited to, odor development, decrease in pH, decrease in dissolved oxygen concentration, changes in emulsion stability (for water soluble oils and semisynthetic fluids), increased incidence of dermatitis, diseases such as but not limited to, hypersensitivity pneumonitis, workpiece surface-finish blemishes, clogged filters and lines, increased workpiece rejection rates, decreased tool life, and generally unpredictable changes in coolant chemistry. See, for example, Frederick J. Passman, “Microbial Problems in Metalworking Fluids,” Lubrication Engineering, pp. 431-3, May 1988; and 1. Mattsby-Baltzer et al., “Microbial Growth and Accumulation in Industrial Metal-Working Fluids,” Applied and Environmental Microbiology, October 1989, pp. 2681-2689.

Among the bacteria that are commonly found in MWF's are aerobic bacteria, such as but not limited to, Pseudomonas aeruginosa; anaerobic sulfate-reducing bacteria, such as but not limited to, Desulfovibrio desulfuricans; and nontuberculous mycobacteria, such as but not limited to, Mycobacteria chelonei, fortuitum, and immunogenum. Examples of prominent fungal contaminants of MWF include, but are not limited to, Fusarium and Cephalosporium species. Among the yeasts, Candida and Trichosporon species are often isolated from contaminated MWF's. To combat the negative affects of microbial growth in industrial fluid compositions, such fluid compositions are typically treated with a range of biocides and/or fungicides to control microbial growth.

In large manufacturing plants, MWF are used in large (up to several tens of thousands of gallons) central systems that hold the fluid in a large tank and distribute it to each machine as it is needed. At the machine, the fluid is sprayed at high pressure into the interface between the machine tool and the metal part being machined. Fluid then returns to the central holding tank after being filtered to remove mobilized metal chips. Due to evaporation, spillage, and carry-off on the parts, generally about 3% to about 5% of the volume of the system is lost per day and must be replaced with new fluid. Systems gradually become dirty with use and are usually completely dumped and recharged once or twice per year, depending on the application, local environment, and the individual manufacturer's practices. This necessitates the waste treatment and disposal of the entire volume of fluid. If this fluid contains a phenolic biocide when it is sent to waste treatment, the cost is in many cases significantly increased.

The use of MWF in industrial environments has problems associated therewith that must be solved for successful manufacturing. Such fluids contain many ingredients that are susceptible to degradation by bacteria and fungus. In the absence of appropriate control measures, MWF will quickly be overgrown by bacteria such as Pseudomonas, Desulfovibrio, or Mycobacteria species, or fungus such as Fusarium species, resulting in a loss of function and catastrophic failure of the manufacturing process (Rossmoore, H. W., Rossmoore, L. A. Effect of Microbial Growth Products on Biocide Activity in Metalworking Fluids. International Biodeterioriation 1991, 27:145-156, and Rossmoore, L. A., Rossmoore, H. W. Metalworking Fluid Microbiology in Byers, J. P. (Ed.), Metalworking Fluids. New York: Marcel Dekker 1994, pp 247-271). In addition, some of these microorganisms, especially mycobacteria, are potential human pathogens (Beckett, W., Kallay M., Sood A., Zuo Z., Milton D. Hypersensitivity pneumonitis associated with environmental mycobacteria. Environmental Health Perspectives 2005, 113:767-770, and Passman, F. J., Rossmoore, H. W. Reassessing the health risks associated with employee exposure to metalworking fluid microbes. Lubrication Engineering July 2002, 30-38).

The problems of uncontrolled microbial growth in MWF can be addressed by the use of appropriate microbicides as components of the fluid. There are a number of EPA-registered biocides and fungicides which are used in this application, including but not limited to, amine-formaldehyde condensates, isothiazolines, carbamates, and phenolic derivatives. All have strengths; none is perfectly suited to this use. One example of a microbicides utilized for this application is the phenolic derivative parachlorometacresol (PCMC). PCMC's range of action (more aggressive against fungus than bacteria, more active against sulfate-reducing bacteria (SRB) and Mycobacteria than Pseudomonas) is very well suited to the requirements of MWF, where fungus and SRB are better able to destroy function, and where Mycobacteria are more dangerous than Pseudomonas. Additionally, PCMC has a very wide “therapeutic index” in that the level required to be effective against microbes is much lower than the levels at which the compound is toxic to humans (Rossmoore, H. W. Biocides for metalworking lubricants and hydraulic fluids. In Rossmoore, H. W. (ed) Handbook of Biocide and Preservative Use. New York: Blackie Academic and Professional 1995, pp 133-156).

However, PCMC suffers from one major drawback which prevents its widespread use in MWF: PCMC is classified as a persistent aquatic pollutant, and therefore many municipalities refuse to accept PCMC-containing fluids into their waste-treatment systems. This means that waste treatment of PCMC-containing fluids is more expensive, as most of the PCMC needs to be removed from the fluid before it is sent to a Publicly Owned Treatment Work (POTW). For this reason, many companies have refused to consider using PCMC-containing MWF in their systems despite the significant functional advantages PCMC would offer. This reluctance is especially prevalent in large transnational manufacturing companies such as GM, Ford, and DaimlerChrysler, which collectively represent a significant fraction of the worldwide use of MWF.

If a solution could be found for the waste treatment problems of PCMC, its use in MWF fluid would increase significantly. Because PCMC is such an effective microbicide in this application, this would have the effect of controlling total manufacturing costs as well as reducing the exposure of manufacturing workers to potentially pathogenic microbes. Additionally, because the total volume of MWF used in North America is expected to stay nearly the same during this period, it is likely that the increased PCMC use would displace and reduce the volume of other, more toxic biocides in this market.

PCMC is a chlorinated phenol that is predominantly water-soluble at elevated pH (pH >8.0). It and other phenolic biocides can be degraded by the action of bacteria as well as by addition of a number of strong oxidizers into the MWF. Previous attempts to solve the problem of phenolic biocide waste treatment have used either bacterial degradation approaches, electrolytic degradation, supercritical water/potassium persulfate (Kronholm, J. et al. Environ. Sci. Technol. (2001) 35:324), or the use of chlorine bleach, hydrogen peroxide, or potassium permanganate. These approaches have all failed commercially for various reasons, including but not limited to, an undesirable extended length of a process time, incompatibility with current waste-treatment practices, excessive expense, or the introduction of additional problematic molecules or elements (e.g., dioxins or manganese) into the system.

The Collins laboratory at Carnegie Mellon University has developed a family of molecules that are excellent oxidative catalysts. These Tetra-Amido Macrocyclic Ligand (TAML®) catalysts are activated by hydrogen peroxide to effect the catalytic degradation of organic molecules (Gupta et al. (2002) Science, 296:326-8; and Wingate et al. (2004) Water Sci Technol., 49:255-60). The structures of representative Tetra-Amido Macrocyclic Ligands which can be utilized in accordance with the present invention are shown in FIGS. 1 and 2. These catalysts are being developed for uses including paper mill effluent treatment, dye transfer inhibition, anti-soil redeposition, and stain removal. However, their use in degradation of phenolic biocides present in industrial fluid compositions, or the use of any oxidative catalyst in the degradation of phenolic biocides present in such fluid compositions, has not previously been contemplated.

Presently, the prior art fails to teach or disclose methods for waste treating phenolic biocides cost-effectively in a manner that (i) is compatible with existing procedures of system dumping and recharging, and (ii) does not introduce additional problematic molecules. Therefore, a need exists in the art for improved methods of phenolic biocide degradation in fluid compositions that overcome the disadvantages and defects of the prior art.

### BRIEF DESCRIPTION OF THE DRAWINGS

FIG. 1 graphically illustrates the structures of three representative Tetra-Amido Macrocyclic Ligand catalysts known in the art.

FIG. 2 graphically illustrates the structure of one of the family of Tetra-Amido Macrocyclic Ligand catalysts.

FIG. 3A graphically demonstrates that the Tetra-Amido Macrocyclic Ligand catalyst is necessary for PCMC degradation in the presence of hydrogen peroxide. FIG. 3B graphically illustrates that hydrogen peroxide is necessary for the activity of Tetra-Amido Macrocyclic Ligand catalyst to degrade PCMC. In both experiments, a single addition of each of the Tetra-Amido Macrocyclic Ligand catalyst and hydrogen peroxide at the indicated concentrations was made to a fresh 10% (w/w) solution of TRIM SOL®, and then the mixture was incubated for 20 minutes at room temperature.

FIG. 4 graphically illustrates the levels of PCMC remaining in the metalworking fluid after one, two or four additions of oxidative catalyst. The vertical axis represents ppm of PCMC remaining in the fluid after the experiment. Experimental conditions were as follows: total incubation time was 20 minutes (in the case of two additions of catalyst, the additions were 10 minutes apart, and for four additions of catalyst, the additions were 5 minutes apart); one addition of hydrogen peroxide to a final concentration of 30 mM; and the one, two or four additions of oxidative catalyst provided a total catalyst concentration of 1 μM (two additions were 0.5 μM each, while four additions were 0.25 μM each). In the case of 2 and 4 additions of oxidative catalyst, the final addition resulted in complete degradation of PCMC; this bar is therefore not visible in the figure. Aliquots were removed from the assay for PCMC concentration evaluation during the experiment; the amount of Tetra-Amido Macrocyclic Ligand catalyst added after removal of the aliquots was adjusted accordingly.

FIG. 5 graphically represents a time course of PCMC degradation at two different concentrations of oxidative catalyst. Hydrogen peroxide was added to a final concentration of 30 mM, and a single addition of Tetra-Amido Macrocyclic Ligand catalyst was added either at 1 or 2 μM concentrations. Aliquots were removed from the assay for PCMC concentration evaluation during the experiment; the amount of Tetra-Amido Macrocyclic Ligand catalyst added after removal of the aliquots was adjusted accordingly.

FIG. 6 graphically represents the effect of pH on degradation of PCMC present in the metalworking fluid TRIM SOL®. This experiment is the result of a single addition of catalyst at 2 μM and a single addition of peroxy compound at 30 mM, followed by a 20 minute room temperature incubation. The vertical axis is ppm of PCMC remaining in the fluid after the experiment.

FIG. 7 graphically illustrates the degradation of PCMC present in new TRIM SOL® and two used samples of TRIM SOL® at increasing peroxide concentration. This experiment was carried out with two additions of Tetra-Amido Macrocyclic Ligand catalyst at 1 μM each, the second after incubation for 15 minutes at room temperature. Final PCMC concentrations were measured 15 minutes after the second Tetra-Amido Macrocyclic Ligand catalyst addition. The vertical axis is ppm of PCMC remaining in the fluid after the experiment.

### DETAILED DESCRIPTION OF EXEMPLARY EMBODIMENTS OF THE INVENTION

Before explaining at least one embodiment of the invention in detail by way of exemplary drawings, experimentation, results, and laboratory procedures, it is to be understood that the invention is not limited in its application to the details of construction and the arrangement of the components set forth in the following description or illustrated in the drawings, experimentation and/or results. The invention is capable of other embodiments or of being practiced or carried out in various ways. As such, the language used herein is intended to be given the broadest possible scope and meaning; and the embodiments are meant to be exemplary—not exhaustive. Also, it is to be understood that the phraseology and terminology employed herein is for the purpose of description and should not be regarded as limiting.

Unless otherwise defined herein, scientific and technical terms used in connection with the present invention shall have the meanings that are commonly understood by those of ordinary skill in the art. Further, unless otherwise required by context, singular terms shall include pluralities and plural terms shall include the singular. The foregoing techniques and procedures are generally performed according to conventional methods well known in the art and as described in various general and more specific references that are cited and discussed throughout the present specification. The nomenclatures utilized in connection with, and the laboratory procedures and techniques of, analytical chemistry, synthetic organic chemistry, and medicinal and pharmaceutical chemistry described herein are those well known and commonly used in the art. All patents, patent applications, publications, and literature references cited in this specification are hereby incorporated herein by reference in their entirety.

As utilized in accordance with the present disclosure, the following terms, unless otherwise indicated, shall be understood to have the following meanings:

The term “fluid composition” as utilized herein will be understood to include metalworking fluids, but is not to be considered limited thereto. Rather, the term “fluid composition” as utilized in accordance with the present invention will also be understood to include any industrial fluid composition in which microbial contamination is observed, such as but not limited to, industrial cleaning systems, industrial waste liquids, nuclear waste liquids, plating solutions, etching solutions, cooling tower systems, water treatment systems, fuel storage systems, refinery systems, crude oil well systems, municipal waste treatment systems and the like, as well as other compositions in which phenolic biocides are used to impart protection from microbial growth to other objects, such as but not limited to, leather tanning and processing fluids, fluids utilized to wash citrus and other fruit, food grade lubricants, and the like.

The terms “metalworking fluid” and “MWF”, as used herein, will be understood to refer to a complex fluid composition that is applied to an interface between a tool and a metallic workpiece during the shaping of the workpiece by physical means, such as but not limited to, grinding, machining, turning, rolling, punching, extruding, spinning, drawing and ironing, pressing and drilling, stamping and forming, and the like. MWF can be broadly categorized as oils and aqueous based liquids or fluids. The oils are non-aqueous liquids comprising an oil or mixture of oils and one or more additives, such as for example, surfactants, extreme pressure agents, corrosion inhibitors, bactericides, fungicides and odor control agents. Aqueous based metalworking fluids are complex combinations of water, lubricant and additives. Aqueous based metalworking fluids can be classified as soluble oils, synthetic fluids and semi synthetic fluids.

The term “microbe” as used herein will be understood to refer to any prokaryotic, single-celled eukaryotic or protist organism, including but not limited to, bacteria, mycobacteria, fungi, and yeast. All the techniques described in this document can be adapted for the simultaneous detection, enumeration, and viability analysis of any single celled organism or group of organisms that are present in a homogenous or mixed population, as planktonic organisms or as part of a biofilm or biomass; as well as for the simultaneous detection, enumeration, and viability analysis of dissociated monomeric cells of a multicellular organism, including but not limited to, plants, algae, sponges, and animals that are present in a homogenous or mixed population.

The term “phenolic biocide” as used herein will be understood to refer to any molecule, whether registered with the EPA under FIFRA as an insecticide or not, which has the property of killing microbes when added to a fluid composition, and which either has a free phenolic moiety, a derivatized phenolic moiety (for example but not by way of limitation, phenoxyethanol), or degrades in the fluid resulting in the release of molecules with free phenolic moieties. Examples of phenolic biocides include but are not limited to, phenol, orthophenylphenol (OPP), phenoxyethanol, parachlorometacresol (PCMC), and parachlorometaxylenol (PCMX).

The term “oxidative catalyst” as used herein will be understood to refer to any molecule or supramolecular complex which has the property of catalytically oxidizing organic molecules. Such molecules are often, but not always, activated by peroxides and similar molecules (collectively referred to herein as “peroxy compounds” as defined herein below). One common use for such oxidative catalysts is in the detergent art as bleaching additives/stain removers. Examples of oxidative catalysts that may be utilized in accordance with the present invention include, but are not limited to, TAML® and TINOCAT® catalysts (both of which are described in more detail herein below), oxidative zeolites, other known catalysts that function in the same manner as the TAML® or TINOCAT® catalysts, combinations thereof, and the like.

The term “catalyst” as used herein will be understood to include precatalysts as well as actual catalyst complexes, where the latter is the species that carries out the oxidation.

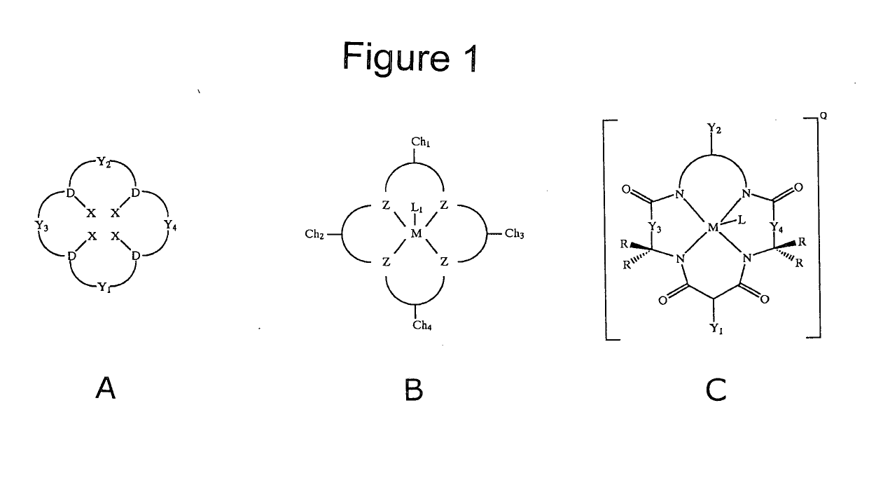

The terms “TAML® catalyst” and “Tetra-Amido Macrocyclic Ligand Catalyst” as used herein will be understood to refer to a Tetra-Amido Macrocyclic Ligand catalyst that is activated by hydrogen peroxide to effect the catalytic degradation of organic molecules. Examples of TAML® catalysts that may be utilized in accordance with the present invention are described in detail is U.S. Pat. Nos. 5,847,120, issued to Collins and Gordon-Wiley on Dec. 8, 1998; 5,853,428, issued to Collins and Horwitz on Dec. 29, 1998; 5,876,625, issued to Collin and Horwitz on Mar. 2, 1999; 6,011,152, issued to Gordon-Wylie and Collins on Jan. 4, 2000; 6,051,704, issued to Gordon-Wylie and Collins on Apr. 18, 2000; 6,054,580, issued to Collins et al., on Apr. 25, 2000; 6,099,586, issued to Collins and Horwitz on Aug. 8, 2000; 6,100,394, issued to Collins and Gordon-Wylie on Aug. 8, 2000; 6,136,223, issued to Collins and Horwitz on Oct. 24, 2000; and 6,241,779, issued to Collins and Horwitz on Jun. 5, 2001. The entire contents of each of the above-referenced patents are hereby expressly incorporated herein by reference. In addition, FIG. 1 depicts the structures of various TAML® catalysts disclosed in the above-referenced patents. The structures shown in FIG. 1 will be described in greater detail herein below.

The term “TINOCAT® catalyst” as used herein will be understood to refer to a granulated metal-containing catalyst produced by Ciba Specialty Chemicals Corporation (High Point, N.C.). Such oxidative catalysts function as a bleaching additive/stain remover that is activated by formulations containing peroxygen compounds to deliver active oxygen, and are utilized in laundry care products and automatic dishwasher powder/tablets.

The term “oxidative zeolite” as used herein will be understood to refer to any zeolite which has been derivatized with a metal or other functionality in such a way as to have the ability to oxidize organic molecules. Examples of such zeolites are found in U.S. Pat. No. 6,248,684, issued to Yavuz et al. on Jun. 19, 2001; and in Milojevic et al. (Materials Science Forum (2007) 555:213-8), both of which are expressly incorporated herein by reference in their entirety.

The term “peroxy compound” as used herein will be understood to include any organic or inorganic compound that yields peroxide in aqueous or non-polar liquids. The phrase “peroxy compound that yields peroxide” as used herein will be understood to include any compound that can generate peroxide in aqueous or non-polar liquid, as well as any compound that is itself a peroxide, either in aqueous or non-polar liquid. Exemplary compounds include, but are not limited to, hydrogen peroxide, hydrogen peroxide adducts, compounds capable of producing hydrogen peroxide in aqueous solution, organic peroxides (including, but not limited to, butyl peroxides, percarbonates and peracetates), persulfates, perphosphates, persilicates and molecular oxygen. Hydrogen peroxide adducts include alkali metal (e.g., sodium, lithium, potassium) carbonate peroxyhydrate and urea peroxide. Compounds capable of producing hydrogen peroxide in aqueous solution include alkali metal (sodium, potassium, lithium) perborate (mono- and tetrahydrate). The perborates are commercially available from such sources as Akzo N. V., and FMC Corporation. Alternatively, an alcohol oxidase enzyme and its appropriate alcohol substrate can be used as a hydrogen peroxide source. Organic peroxides include, without limitation, benzoyl and cumene hydroperoxides. Persulfates include potassium peroxymonosulfate (sold as Oxone®, E. I. du Pont de Nemours) and Caro's acid.

The present invention is related to methods of degrading a phenolic biocide present in a fluid composition, wherein such method utilizes an oxidative catalyst. The oxidative catalyst is activated by a peroxy compound and becomes a very effective oxidant with a particular affinity for phenolic moieties. This allows it to degrade PCMC and other phenolic biocides at the pHs normally found in used metalworking fluid, and also to remain active against the desired target molecules even in the presence of relatively high levels of other organic molecules. In the course of use, the oxidative catalyst is relatively unstable and quickly breaks down to nontoxic degradation products. This has the benefit of ensuring that it is not itself a hazardous or persistent substance.

Broadly, the method includes the steps of determining the initial concentration of phenolic biocide to be degraded, adjusting the system physical and chemical parameters to the optimum for degradation, adding an appropriate amount of peroxide (or a peroxide-producing compound) to the system to activate the oxidative catalyst, adding an appropriate amount of such catalyst to the system to degrade the phenolic biocide (in one or more aliquots over a period of time), and then determining the final concentration of phenolic biocide to confirm that effective degradation took place. These method steps can be performed in any suitable order and may be repeated as necessary, until a desired level of phenolic biocide is achieved.

Before beginning the biocide degradation process, a sample of the fluid composition may be taken and tested to determine the initial concentration of phenolic biocide present in the fluid composition. This step may be performed to ensure that (i) enough biocide is present to require the use of the oxidative catalyst for degradation, and (ii) to assess the level of success of the process. Appropriate standard concentration determination techniques are well known in the art, and a person having ordinary skill in the art can easily select such appropriate technique based on the specific type of fluid composition to be tested. Therefore, any appropriate methods known in the art for testing of the fluid to determine the phenolic biocide concentration can be utilized, including but not limited to, the 4-amino antipyrene method (4-AAP), HPLC or GC methods, and the like. However, it is not necessary to know an initial concentration of phenolic biocide present in said fluid composition, and therefore this step may be omitted.

Next, the pH of the system is determined, and then if necessary, the pH is adjusted by the appropriate addition of acid or base so that the pH falls within a range of from about 6.5 to about 10.5. In one embodiment, the pH is adjusted to a range of from about 7.5 to about 9.0. This range is the usual range of optimal activity of oxidative catalysts in coarse emulsion systems such as soluble oils. Generally, the higher end of this pH range is more advantageous.

The total system volume is then determined. The total system volume may be determined by direct methods, or the total system volume may be determined by simply estimating the total system volume. Therefore, the phrase “determining the total system volume of said fluid composition” will include both direct determinations of the total system volume as well as indirect methods and estimates thereof.

Next, an effective amount of a peroxy compound is added, wherein the peroxy compound generates peroxide in aqueous or non-polar solution. Generally, the peroxy compound is added in an amount sufficient to achieve a final peroxide concentration in a range between about 10 mM and 150 mM. In one embodiment, the final peroxide concentration falls within a range of from about 60 mM to about 90 mM. The system may be mixed before, during and/or after addition of the peroxy compound. In one embodiment, a sufficient amount of mixing time is provided to achieve homogeneity of the peroxide within the system. Use of system circulation pumps, typically used in metalworking fluid systems, is suitable for mixing purposes.

An effective amount of the oxidative catalyst is then added to the mixture containing the fluid composition and the peroxide-generating peroxy compound, such that the oxidative catalyst is activated by peroxide and reduces the phenolic biocide concentration in the fluid composition. In one embodiment, the oxidative catalyst is a Tetra-Amido Macrocyclic Ligand catalyst, which may be provided in the form of (1) a powdered preparation containing the Tetra-Amido Macrocyclic Ligand catalyst in a matrix of inert, water-soluble solid (such as sodium carbonate or sodium sulfate), or (2) a liquid solution of Tetra-Amido Macrocyclic Ligand catalyst dissolved in an appropriate solvent (such as but not limited to, 0.001 M to 0.5 M NaOH in water). The effective amount of oxidative catalyst may provide a final concentration in a range of from about 0.125 μM to about 4 μM. In one embodiment, the effective amount of oxidative catalyst provides a final concentration in a range of from about 0.25 μM to about 2 μM.

Examples of Tetra-Amido Macrocyclic Ligand catalysts that may be utilized in accordance with the present invention are depicted in the structures shown in FIG. 1.

FIG. 1A illustrates the structure of a long-lived homogeneous amide-containing macrocyclic compound disclosed in U.S. Pat. No. 6,054,580 (which has previously been incorporated herein by reference). In FIG. 1A, Y₁, Y₂, Y₃ and Y₄ are oxidation resistant groups which are the same or different and which form 5- or 6-membered rings with a metal, M, when bound to D. D is a metal complexing donor atom, O or N. Each X is a position for addition of a substituent and, when D is N, each position is (i) not occupied such that a double bond is formed between D and an atom adjacent to D, or (ii) is selected from the group consisting of hydrogen, alkyl, alkenyl, alkynyl, aryl, alkoxy, phenoxy, halogen, halogenated alkyl, halogenated aryl, halogenated alkenyl, halogenated alkynyl, perhaloalkyl, perhaloaryl, a substituted or unsubstituted cycloalkyl ring, a substituted or unsubstituted cycloalkenyl ring, a substituted or unsubstituted saturated heterocyclic ring, a substituted or unsubstituted unsaturated heterocyclic ring, and at least one X is hydrogen, and when D is 0, the position is not occupied.

FIG. 1B illustrates the structure of an oxidative catalyst disclosed in U.S. Pat. No. 5,847,120 (which has previously been incorporated herein by reference). In FIG. 1B, M is a metal, preferably a transition metal; Z is an anionic donor atom, at least three of which are nitrogen and the other is preferably nitrogen or oxygen; L, is a labile ligand; and Ch₁, Ch₂, Ch₃ and Ch₄ are oxidation resistant chelate groups which are the same or different and which form 5 or 6 membered rings with the metal.

FIG. 1C illustrates the structure of a metal ligand containing bleaching composition disclosed in U.S. Pat. No. 5,853,428 (which has previously been incorporated herein by reference). In FIG. 1C, Y₁, Y₃ and Y₄ each represents a bridging group, i.e., zero, one, two or three carbon containing nodes for substitution, while Y₂ is a bridging group of at least one carbon containing node for substitution, each said node containing a C(R), C(R₁)(R₂), or a C(R)₂ unit, and each R substituent is the same or different from the remaining R substituents and is selected from the group consisting of H, alkyl, cycloalkyl, cycloalkenyl, alkenyl, aryl, alkynyl, alkylaryl, halogen, alkoxy, phenoxy, CH₂CF₃, CF₃ and combinations thereof, or form a substituted or unsubstituted benzene ring of which two carbon atoms in the ring form notes in the Y unit, or together with a paired R substituent bound to the same carbon atom form a cycloalkyl or cycloalkenyl ring, which may include an atom other than carbon, e.g., cyclopentyl or cyclohexyl; M is a transition metal with oxidation states of I, II, III, IV, V, VI, VII or VIII or selected from Groups 3, 4, 5, 6, 7, 8, 9, 10, and 11 of the Periodic Table; Q is any counterion which would balance the charge of the compound on a stoichiometric basis; and L is any labile ligand.

However, it is to be understood that the structures of oxidative catalysts provided in FIG. 1 are for representative purposes only, and thus the present invention is not limited to the structures of oxidative catalysts shown in FIG. 1. Rather, any oxidative catalyst described herein or otherwise known in the art may be utilized in accordance with the methods of the present invention.

Following addition of the oxidative catalyst, the system is allowed to continue mixing for an appropriate amount of time. In one embodiment, the system may be allowed to continue mixing for about 15 to about 60 minutes. Then, a fluid sample may be taken and analyzed for residual phenolic biocide present in the fluid composition (as described in detail herein below). Optionally, an additional dose of oxidative catalyst may be added prior to analysis of the residual phenolic biocide level of the fluid composition.

As stated above, the method may further include a second addition of oxidative catalyst added to the system before or after analysis of residual phenolic biocide present in the fluid composition. This second dose is in an amount sufficient to achieve an additional catalyst concentration in a range of from about 0.125 μM to about 4 μM in addition to the first addition. That is, the final catalyst concentration after a second dose of oxidative catalyst provides a final catalyst concentration in a range of from about 0.25 μM to about 8 μM. In one embodiment, the final catalyst concentration after a second dose of oxidative catalyst provides a final catalyst concentration in a range of from about 0.5 μM to about 4 μM. Following addition of this second does of catalyst, the system may be allowed to continue mixing for about 15 minutes to about 60 minutes.

Following addition of one or more doses of oxidative catalyst, a fluid sample is taken and analyzed to determine the concentration of residual phenolic biocide present in the fluid sample. In this analysis, it is determined whether the residual phenolic biocide concentration present in the fluid composition is below a local discharge limit. A local discharge limit is generally about one part per million of phenolic biocide. If the residual phenolic biocide concentration is below the local discharge limit, then the fluid composition may be disposed of, for example, in a waste treatment facility.

If the residual phenolic biocide concentration in the fluid composition is above the local discharge limit (i.e., above one part per million phenolic biocide), at least one more dose of oxidative catalyst is added to the fluid composition containing the peroxy compound (generally adding another 0.125 μM to about 4 μM to the final concentration of catalyst present in the fluid composition), and the system allowed to mix again for about 15 minutes to about 60 minutes. Following the addition of one or more additional doses of oxidative catalyst, a fluid sample is then taken and analyzed as described above to determine if the residual phenolic biocide concentration is below the local discharge limit.

The steps of (1) adding the oxidative catalyst and (2) analyzing a sample of the fluid composition may then be repeated as necessary until the residual phenolic biocide concentration present in the metal working fluid composition is below a local discharge limit.

While a general range of final oxidative catalyst concentration has been provided herein, it is to be understood that the present invention is not limited to such amount of catalyst. Rather, any amount of catalyst may be utilized in accordance with the present invention. The factors to be considered when selecting such amount include (1) the ratio of catalyst to peroxide, and (2) the depletion of available peroxide added to the system. Thus, the method may further include a step of adding an additional amount of peroxy compound, if necessary, when additional doses of oxidative catalyst are added, to prevent the depletion of available peroxide in the system.

After the concentration of biocide in the system is less than the local discharge limit, the fluid is sent for waste treatment according to standard methods.

An Example is provided hereinbelow. However, the present invention is to be understood to not be limited in its application to the specific experimentation, results and laboratory procedures. Rather, the Example is simply provided as one of various embodiments and is meant to be exemplary, not exhaustive.

### EXAMPLE

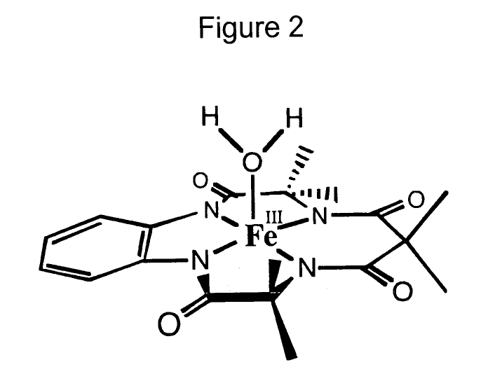

Tests of the TAML® catalyst have been performed on a number of MWF, both new and used, in order to define the optimal conditions of use. Most of the tests described herein were performed on TRIM SOL® (Master Chemical Corporation, Perrysburg, Ohio), as it is one of the most widely used PCMC-containing MWF sold today. A number of other fluids, both new and used, have been tested and also found to support PCMC degradation under identical conditions. For the experiments described herein below, the oxidative catalyst shown in FIG. 2 was utilized.

All of the data on PCMC levels present in MWF samples that are shown below were obtained by using a modification of the standard 4-MP test (EPA method 420.1, Phenolics (spectrophotometric, manual 4-AAP with distillation), as follows: first, the volumes were reduced so that the total volume of the test was approximately 1.2 ml, and second, after the test was completed, the colored reaction product was extracted in chloroform and assayed on a spectrophotometer. This allowed for the conversion of a normally qualitative test into a quantitative one, wherein such test obtained actual PCMC concentrations by comparing the results to a standard curve of PCMC samples.

As stated above, PCMC determinations were performed by a modification of the standard EPA method 420.1, Phenolics (spectrophotometric, manual 4-AAP with distillation). This method is known and referred to herein as the “4-aminoantipyrene” or “4-MP” test. Briefly, 200 μl of the test fluid was removed from the reaction or control as appropriate and placed in a 1.5 ml Eppendorf tube. 1 ml of distilled H₂O was added and mixed. 18 μl of Hach Buffer Solution Hardness 1 (available from Hach Co., Loveland Colo. as catalog #42453) was added and the solution mixed. 7 μl of a 2% (w/w) solution of 4-aminoantipyrene was added and the solution mixed. 18 μl of a 3% (w/w) solution of potassium ferricyanide was added and the solution mixed. Both the 4-aminoantipyrene and potassium ferricyanide solutions were prepared fresh daily. The reactions were allowed to incubate at room temperature for 15 minutes to ensure complete color development. For qualitative assays, the results were determined by visual observation of the color development. For quantitative assays, the results were obtained spectrophotometrically. To create an accurate standard concentration curve for PCMC, known concentrations of PCMC obtained by diluting samples of PREVENTOL® CMK-40 (Lanxess, Pittsburgh, Pa.; PCMC 40% w/w) were subjected to the modified 4-AAP test as described above. Upon completion of the color development, samples were transferred to 10 ml conical glass tubes. 1.5 ml chloroform was added and the samples mixed. After the phases separated, 1 ml of the chloroform phase containing the colored adduct was removed, and the absorbance was determined in a spectrophotometer at 460 nm using a capped glass or quartz cuvette. A standard curve relating absorbance and PCMC concentration was obtained from these data. Experimental samples were treated in the same manner, and the absorbance was compared to the standard curve to derive a PCMC concentration.

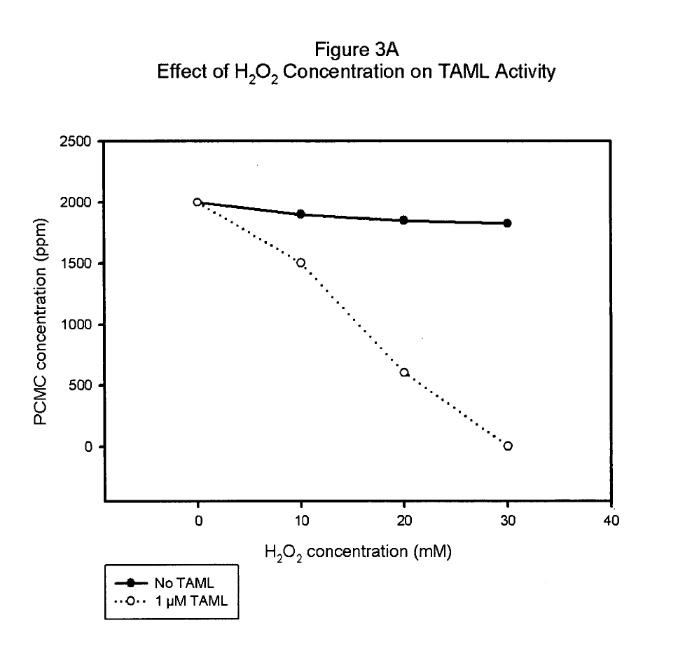

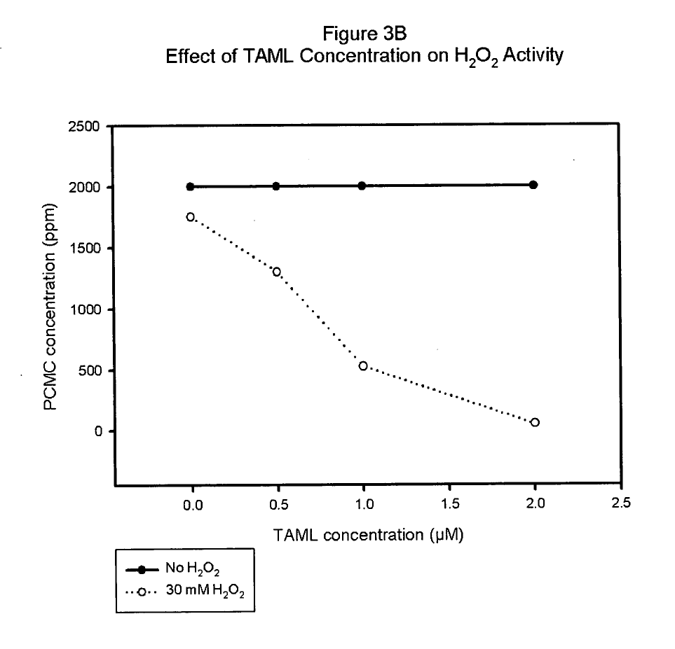

In the experiment shown in FIG. 3, the effect of changing the catalyst concentration (FIG. 3B) or the peroxide concentration (FIG. 3A) on PCMC degradation activity was tested. It is evident that both catalyst and peroxide are necessary for activity, and that 30 mM peroxide and 1 μM catalyst provide for complete PCMC degradation. This experiment was carried out with a single addition of catalyst at room temperature followed by a 20 minute incubation. Although a single addition of catalyst at 1 μM concentration is sufficient to completely degrade the PCMC in the solution, in practice it is more efficacious to use two additions with a total catalyst concentration of 2 μM.

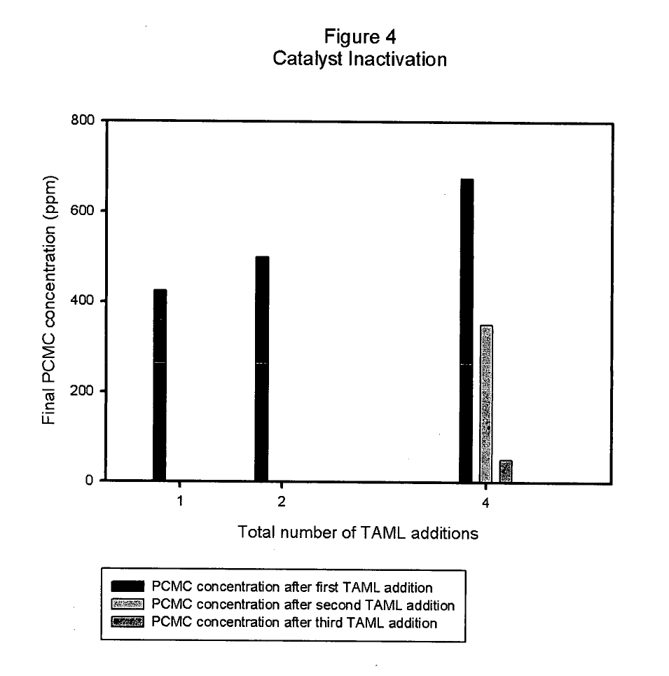

Next, the possibility that the catalyst was being degraded or inactivated during the reaction was tested. As can be seen in FIG. 4, multiple additions of catalyst are more effective than a single addition, even with the same total amount of catalyst. In one embodiment, two additions of catalyst, each at 1 μM, appears to provide the best tradeoff between effectiveness and user convenience.

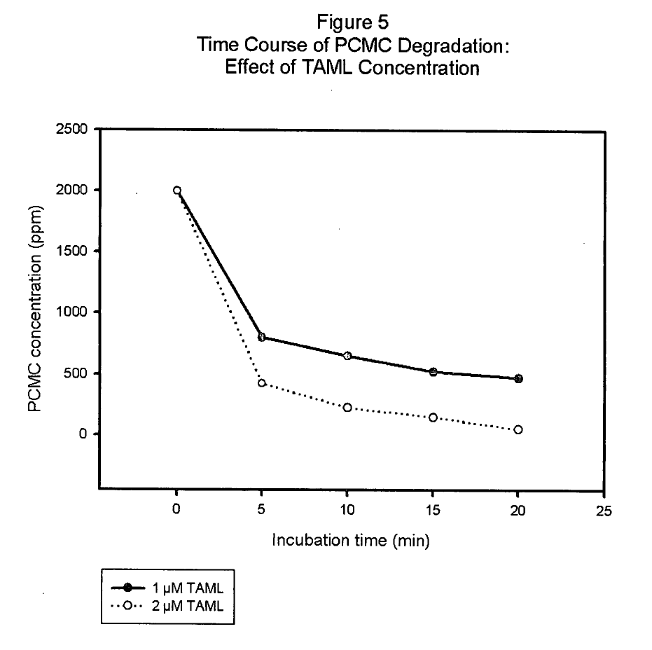

Using a single addition of catalyst and 30 mM peroxide, it was possible to determine that most of the reaction is complete within 10-15 minutes (FIG. 5). The incubation time may be extended to 20 minutes for each catalyst addition to ensure that the PCMC degradation is complete.

However, the present invention is to be understood to not be limited to the specific incubation times provided herein. Rather, a person having ordinary skill in the art would clearly recognize that in some cases, it may be more efficacious to extend the incubation period even further than the reaction periods listed herein.

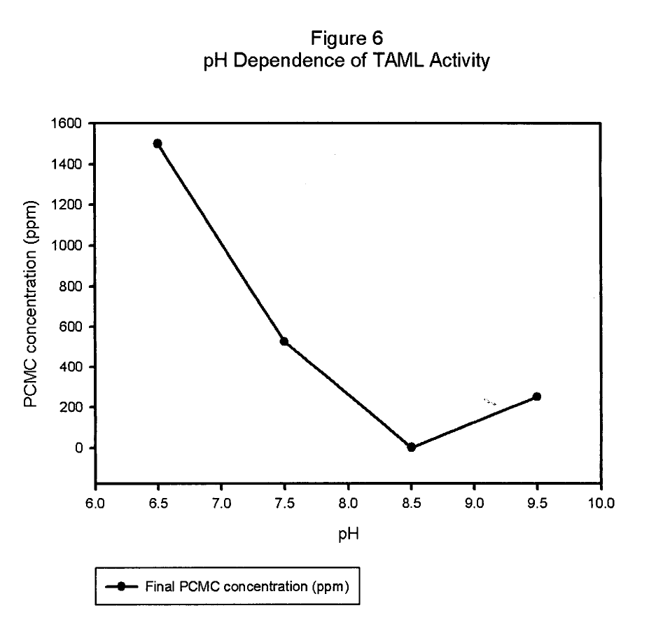

FIG. 6 demonstrates that the effectiveness of the catalyst is maximized at pH 8.5. The optimal pH can vary somewhat from fluid to fluid, and should be tested for each fluid to ensure the maximal benefit from the use of the catalyst. If the used fluid is more than 0.25 pH units away from the optimal pH, it should be adjusted accordingly.

The experiment shown in FIG. 6 is the result of a single addition of catalyst at 2 μM and peroxide at 30 mM. Results using a double addition of catalyst will have a broader range of complete degradation.

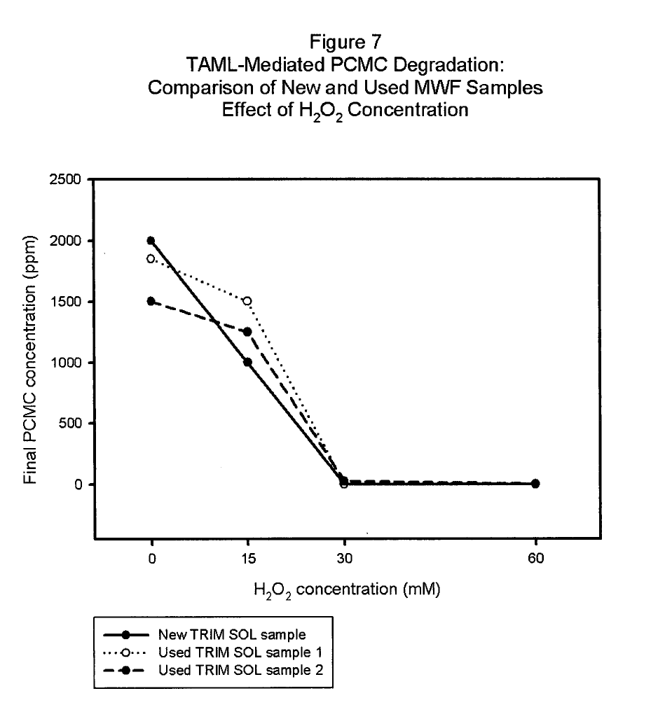

FIG. 7 shows the results of treating two different used samples of MWF in comparison with the results obtained with a fresh sample. As can be seen, at lower peroxide concentrations, the used samples do not experience as complete a PCMC degradation as does the fresh sample. However, at 30 mM peroxide, there is essentially no difference in the amount of PCMC remaining after degradation. This experiment was carried out with two additions of catalyst at 1 μM each, the second following incubation at room temperature for 15 minutes. Final PCMC concentrations were measured 15 minutes after the second Tetra-Amido Macrocyclic Ligand catalyst addition.

Thus, in accordance with the present invention, there has been provided methods for degrading phenolic biocides present in a fluid composition utilizing an oxidative catalyst, wherein such methods that fully satisfy the objectives and advantages set forth hereinabove. Although the invention has been described in conjunction with the specific drawings, experimentation, results and language set forth hereinabove, it is evident that many alternatives, modifications, and variations will be apparent to those skilled in the art. Accordingly, it is intended to embrace all such alternatives, modifications and variations that fall within the spirit and broad scope of the invention.

What is claimed is:

1. A method of degrading phenolic biocides in a fluid composition, said method comprising the steps of:
determining the pH of said fluid composition and if necessary adjusting said pH so that it falls within a range of from about 6.5 to about 10.5;
determining the total system volume of said fluid composition;
adding an effective amount of a peroxy compound to said fluid composition, wherein said peroxy compound yields peroxide in aqueous solution; and
adding an effective amount of an oxidative catalyst to said fluid composition, wherein the oxidative catalyst is activated by peroxide and reduces the phenolic biocide concentration in the fluid composition.

2. The method according to claim 1, further comprising the step of determining an initial concentration of said phenolic biocide in said fluid composition.

3. The method according to claim 1, wherein the fluid composition is a metalworking fluid.

4. The method according to claim 1 wherein, in the step of adding an effective amount of a peroxy compound, the peroxy compound is selected from the group consisting of hydrogen peroxide, a percarbonate, a butyl peroxide, a peracetate, and combinations thereof.

5. The method according to claim 1 wherein, in the step of adding an effective amount of a peroxy compound, the peroxy compound is added in an amount effective to achieve a final peroxide concentration in a range of from about 10 mM to about 150 mM.

6. The method according to claim 1 wherein, in the step of adding an effective amount of an oxidative catalyst, the oxidative catalyst is a Tetra-Amido Macrocyclic Ligand catalyst.

7. The method according to claim 6, wherein the Tetra-Amido Macrocyclic Ligand catalyst is added in an amount effective to achieve a final concentration in a range of from about 0.125 μM to about 4 μM.

8. The method according to claim 1, further comprising the step of analyzing said fluid sample to determine a residual phenolic biocide concentration present after the addition of the oxidative catalyst to determine if the residual phenolic biocide concentration is below a local discharge limit.

9. The method according to claim 8, wherein the local discharge limit of phenolic biocide is about one part per million.

10. The method according to claim 8, further comprising the step of disposing of the fluid composition if the residual phenolic biocide concentration level is below the local discharge limit.

11. The method according to claim 1, further comprising the step of adding a second dose of oxidative catalyst to said fluid composition.

12. The method according to claim 11, wherein the oxidative catalyst is a Tetra-Amido Macrocyclic Ligand catalyst, and wherein the second dose of Tetra-Amido Macrocyclic Ligand catalyst achieves a final concentration of oxidative catalyst in a range of from about 0.25 μM to about 8 μM.

13. A method of degrading phenolic biocides present in a metalworking fluid composition, said method comprising the steps of:
determining the pH of said metalworking fluid composition and if necessary adjusting said pH so that it falls within a range of from about 6.5 to about 10.5;
determining the total system volume of said metalworking fluid composition;
adding an effective amount of a peroxy compound to said metalworking fluid composition, wherein said peroxy compound yields peroxide in aqueous solution; and
adding an effective amount of an oxidative catalyst to said metalworking fluid composition, wherein the oxidative catalyst is activated by peroxide and reduces the phenolic biocide concentration in the metalworking fluid composition.

14. The method according to claim 13, further comprising the step of determining an initial concentration of said phenolic biocide in said metalworking fluid composition.

15. The method according to claim 13 wherein, in the step of adding an effective amount of a peroxy compound, the peroxy compound is selected from the group consisting of hydrogen peroxide, a percarbonate, a butyl peroxide, a peracetate, and combinations thereof.

16. The method according to claim 13 wherein, in the step of adding an effective amount of a peroxy compound, the peroxy compound is added in an amount effective to achieve a final peroxide concentration in a range of from about 10 mM to about 150 mM.

17. The method according to claim 13 wherein, in the step of adding an effective amount of an oxidative catalyst, the oxidative catalyst is a Tetra-Amido Macrocyclic Ligand catalyst.

18. The method according to claim 17, wherein the Tetra-Amido Macrocyclic Ligand catalyst is added in an amount effective to achieve a final concentration in a range of from about 0.125 μM to about 4 μM.

19. The method according to claim 13, further comprising the step of analyzing said fluid sample to determine a residual phenolic biocide concentration present after the addition of the oxidative catalyst to determine if the residual phenolic biocide concentration is below a local discharge limit.

20. The method according to claim 19, wherein the local discharge limit of phenolic biocide is about one part per million.

21. The method according to claim 19, further comprising the step of disposing of the fluid composition if the residual phenolic biocide concentration level is below the local discharge limit.

22. The method according to claim 13, further comprising the step of adding a second dose of oxidative catalyst to said fluid composition.

23. The method according to claim 22, wherein the oxidative catalyst is a Tetra-Amido Macrocyclic Ligand catalyst, and wherein the second dose of Tetra-Amido Macrocyclic Ligand catalyst achieves a final concentration of oxidative catalyst in a range of from about 0.25 μM to about 8 μM.

24. A method of degrading phenolic biocides in a metalworking fluid composition, said method comprising the steps of:
(a) determining the pH of the metalworking fluid composition and if necessary adjusting said pH so that it falls within a range of from about 6.5 to about 10.5;
(b) determining the total system volume of said metalworking fluid composition;
(c) adding an effective amount of a peroxy compound to said metalworking fluid composition, wherein said peroxy compound yields peroxide in aqueous solution, and wherein the peroxy compound is added in an amount effective to achieve a final peroxide concentration in a range of from about 10 mM to about 150 mM;
(d) adding an effective amount of an oxidative catalyst to said metalworking fluid composition, wherein the oxidative catalyst is added in an amount effective to achieve a final concentration in a range of from about 0.125 μM to about 4 μM, and wherein the oxidative catalyst is activated by peroxide and reduces the phenolic biocide concentration in the metalworking fluid composition;
(e) analyzing said metalworking fluid sample to determine whether a residual phenolic biocide concentration present in the metalworking fluid composition is below a local discharge limit;
(f) repeating steps (d) and (e) until the residual phenolic biocide concentration present in the metal working fluid composition is below a local discharge limit; and
(g) disposing of the metalworking fluid composition.

25. The method according to claim 24, further comprising the step of determining an initial concentration of said phenolic biocide in said metalworking fluid composition, wherein such step is performed prior to steps (c)-(g).

26. The method according to claim 24 wherein, in the step of adding an effective amount of a peroxy compound, the peroxy compound is selected from the group consisting of hydrogen peroxide, a percarbonate, a butyl peroxide, a peracetate, and combinations thereof.

27. The method according to claim 24 wherein, in the step of adding an effective amount of an oxidative catalyst, the oxidative catalyst is a Tetra-Amido Macrocyclic Ligand catalyst.

28. The method according to claim 24, wherein the step of (g) further comprises repeating step (c) if necessary to prevent depletion of available peroxide.
